(19) United States
(12) Patent Application Publication
(10) Pub. No.: US 2023/0383721 A1
(43) Pub. Date: Nov. 30, 2023

(54) Wave Energy Converter Using Bucket Turbine and Hydraulic System

(71) Applicants: THINH HOANG DO, HO CHI MINH CITY (VN); TOAN VAN LUU, HO CHI MINH CITY (VN)

(72) Inventors: THINH HOANG DO, HO CHI MINH CITY (VN); TOAN VAN LUU, HO CHI MINH CITY (VN)

(73) Assignee: TON DUC THANG UNIVERSITY, (omitted)

(21) Appl. No.: 15/375,153

(22) Filed: Dec. 11, 2016

(51) Int. Cl. F03B 13/22; F03B 1/02

(52) U.S. Cl. CPC F03B 13/22; F03B 1/02; F05B 2220/705; F05B 2240/95

(57) ABSTRACT

A wave energy converter is disclosed which includes a V-shaped floating frame having a first section and a second section that is narrower than the first section so as to form a V-shaped structure which is hollow in the middle, an anchor base mounted at the bottom of the sea and connected to the V-shaped floating frame at the first end by a set of chords, a first bucket turbine and a second bucket turbine placed in the hollow section and connected to second section so that they are partially submerged in the sea, and an electricity converting assembly operable to receive and convert energy generated by both first bucket turbine and said second bucket turbine into electricity.

### FIELD OF THE INVENTION

This invention generally relates to wave energy converter, hydrostatic transmission. Wave motion is converted to electric energy by the power take-off (PTO) hydrostatic transmission.

### BACKGROUND OF ART

Due to the environment pollution and the exhaustion natural resources, wave energy has become one of the most popular renewable energy nowadays. There have been many attempts to harvest wave energy: the conventional principle of wave energy conversion system, or wave energy converter (WEC), operates based on the principle that wave motion is converted to create high-pressure fluid; the pressurized fluid is then used to drive a hydraulic motor coaxially connected to an electric generator.

In U.S. Pat. No. 6,226,989 (the '989 patent), the disclosed wave energy converter (WEC) includes a pair of a single acting piston pump, three accumulators, check valves, directional valves, and a hydraulic motor. The main accumulator regulates the fluid flow to the hydraulic motor. However, because the displacement of the motor is fixed, the motor speed is still affected by the fluctuation of fluid flow from pumps. In addition, because the fluid flow from pumps to the hydraulic motor must flow across many check valves and directional valves, the efficiency of the system is reduced.

In U.S. Pat. No. 6,574,957, a mechanical and a pneumatic transmission are employed together. The movement of the buoy is transmitted to rotary motion by a rack-and-pinion gear. Then the rotary motion is transmitted again to an oscillating motion by a pair of gears and a crank-slide mechanism. This motion creates high-pressure air by a pair of cylinders, and the pressurized air is stored in a tank. The pressurized air is supplied to a turbine to drive an electrical generator. Again because the wave energy is transfer through many transmissions, the energy loss is increased. Thus efficiency is reduced.

In U.S. Pat. No. 6,812,588 ('588 patent), the wave energy converter includes a hydraulic piston assembly, floatation devices, high and low-pressure reservoirs and a hydraulic driven power generator. A control system is used to detect water conditions and to adjust the length of the support structure and fluid flow characteristics in order to optimize power generation. In addition, fluid discharged from the high-pressure reservoir to the generator is controlled by a discharged valve to ensure that it is at a rated pressure and allows the turbine to rotate continuously. These are advantages of the wave energy converter in the '588 patent. However, there are two drawbacks of pressure control by discharged valve. First, a portion of the energy of the high-pressure fluid is lost via discharged valve. This reduces the efficiency of the system. Second, if wave condition is low, the pressure of high-pressure reservoir is lower than the rated pressure. The generator is then driven at a lower speed. If the driven speed is much lower than rated speed, the wave energy converter cannot generate electricity.

In Pat. No. WO2005/038248 A1 and WO 2006/108421 A1, a WEC consists of a plurality of arms, each of which comprises a float at one end and is connected to a shaft at the opposite end. Each arm is attached to a hydraulic cylinder. A plurality of floats and cylinders can compensate together regardless of wave fluctuation. A plurality of hydraulic motors and generators can adapt to the wave condition. All hydraulic motors and generators can operate if wave condition is high. Conversely, some of hydraulic motors and generators are switched off if wave condition becomes low. In this approach, the driven speed is not controlled but depends on fluid flow from cylinders. Therefore, the driven speed is still affected by the fluctuation of wave and the change of wave condition.

In U.S. Pat. No. 6,551,053B1, a hydro-electric generator consists of a flotation device for producing electricity in areas of flowing water. A paddle wheel is rotatably mounted to the floatation device, and mechanically coupled to the electric generator. The electric generator is then mounted on the floatation device. The floatation device is anchored in a flowing water area so that a current rotates the paddle wheel to produce electricity. This apparatus is simple and easy to install at every flowing water area. However, the paddle wheel, mechanically coupled to the electric generator, often rotates very slowly in case of water flow on the river, or on the sea, thus not generating enough force to produce electricity. Moreover, the cross-area rate of flotation device and the whole device cross-area rate on the perpendicular-to-flow direction is rather large. This limits the electricity generating ability of the device.

Thus, what is needed is a wave energy converter that overcomes the above described problems and achieves high energy-producing efficiency.

### SUMMARY OF THE INVENTION

Accordingly, an objective of the present invention is to provide A wave energy converter is disclosed which includes a V-shaped floating frame having a first section and a second section that is narrower than the first section so as to form a V-shaped structure which is hollow in the middle, an anchor base mounted at the bottom of the sea and connected to the V-shaped floating frame at the first end by a set of chords, a first bucket turbine and a second bucket turbine placed in the hollow section and connected to second section so that they are partially submerged in the sea, and an electricity converting assembly operable to receive and convert energy generated by both first bucket turbine and said second bucket turbine into electricity.

These and other advantages of the present invention will no doubt become obvious to those of ordinary skill in the art after having read the following detailed description of the preferred embodiments, which are illustrated in the various drawing Figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1A is a lateral view of a wave energy converter (WEC) initially placed perpendicular to the direction of the wind and sea waves in accordance with an exemplary embodiment of the present invention.

FIG. 1B is the top view of the wave energy converter of FIG. 1A after it is adjusted by the wind and sea waves to receive the maximum energy in accordance with an exemplary embodiment of the present invention.

FIG. 2 is a top view of the V-shaped floating frame of FIG. 1A and FIG. 1B in accordance with an exemplary embodiment of the present invention.

FIG. 3A is a side view of the anchor of the V-shaped floating frame in accordance with an exemplary embodiment of the present invention.

FIG. 3B is the top view of the anchor of the V-shaped floating frame in accordance with an exemplary embodiment of the present invention.

FIG. 4 is a top view of the wind funnel in accordance with an exemplary embodiment of the present invention.

FIG. 5A is an oblique view illustrating the mechanical structure of the first bucket turbine and the second bucket turbine in accordance with an exemplary embodiment of the present invention.

FIG. 5B is a top view of the first bucket turbine and the second bucket turbine in accordance with an exemplary embodiment of the present invention.

FIG. 6 illustrates a top view of the crank fixed on the shaft of the bucket turbine of FIG. 5A and FIG. 5B in accordance with an exemplary embodiment of the present invention.

FIG. 7 is a side view of the first double rod double acting (DRDA) cylinder and second DRDA cylinder mounted on the cylinder plate on the side of the V-shaped floating frame of FIG. 2 in accordance with an exemplary embodiment of the present invention.

FIG. 8 illustrates the schematic diagram of the electricity converting assembly in accordance with an exemplary embodiment of the present invention.

FIG. 9 is the schematic diagram of the Proportional Integral Derivative (PID) control diagram the Wave Energy Converter (WEC) of FIG. 1 in accordance with an exemplary embodiment of the present invention.

FIG. 10 is a flow chart of the method of converting wave energy into electrical power in accordance with an exemplary embodiment of the present invention.

### DETAILED DESCRIPTION OF THE INVENTION

The invention is detail described with reference to the drawings provided as illustrative examples of the invention.

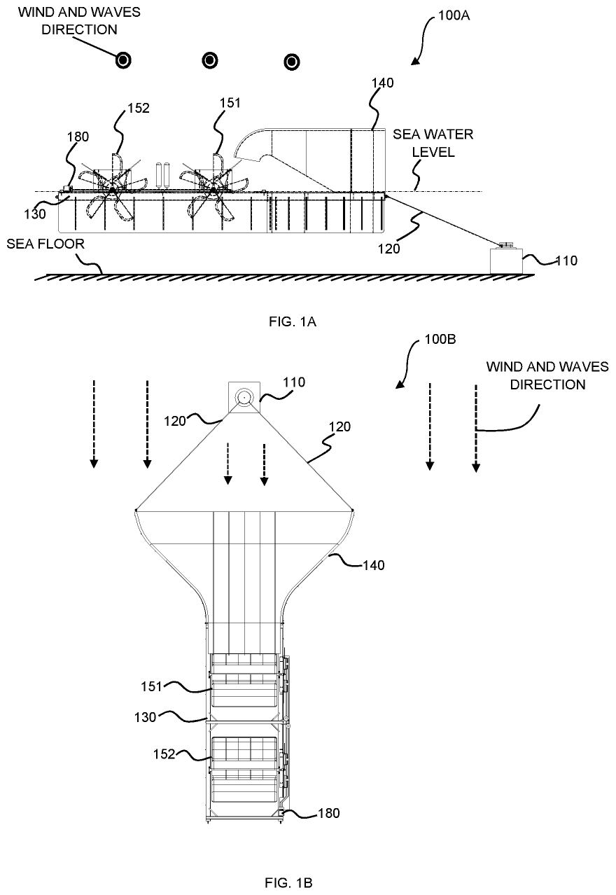

Referring now to FIG. 1A and FIG. 1B, an overview of a wave energy converter which is adapted to adjust itself to receive the maximum energy from the wind and sea waves in accordance with an exemplary embodiment of the present invention is illustrated.

More particularly, FIG. 1A illustrates a lateral view of a wave energy converter 100A which is initially placed near shore on the surface of the sea. Initially, the direction of the wind and sea waves is perpendicular to the main body of the wave energy converter 100A. The direction of the wind and sea waves is represented by dots that are coming from the back of the page toward the viewer. Wave energy converter 100A includes a floating V-shaped frame 130 connected to an anchor 110 by a set of strings 120. Anchor 110 is placed randomly on the sea floor where wave energy converter 100A is set up. On top of floating V-shaped frame 130, a first bucket turbine 151 and a second bucket turbine 152 are mounted that are partially submerged under the sea. An electricity converting assembly 180 is connected to the body of V-shaped floating frame 130. Finally, a wind funnel 140 is mounted on top of V-shaped floating frame 130. The detailed descriptions of the essential elements will be described in later FIGS.

Next, referring to FIG. 1B illustrating a top view of wave energy converter after it adjusts itself to receive the maximum energy from the wind and sea waves. As shown in FIG. 1B, the direction of the wind and sea waves is now parallel to V-shaped floating frame 130 because the wind and sea waves nudge V-shaped frame 130 on the side. Anchor 110 and the structure of V-shaped floating frame 130 allows V-shaped floating frame 130 to turn toward the direction of wind and sea waves as shown in FIG. 1B to harvest the maximum energy.

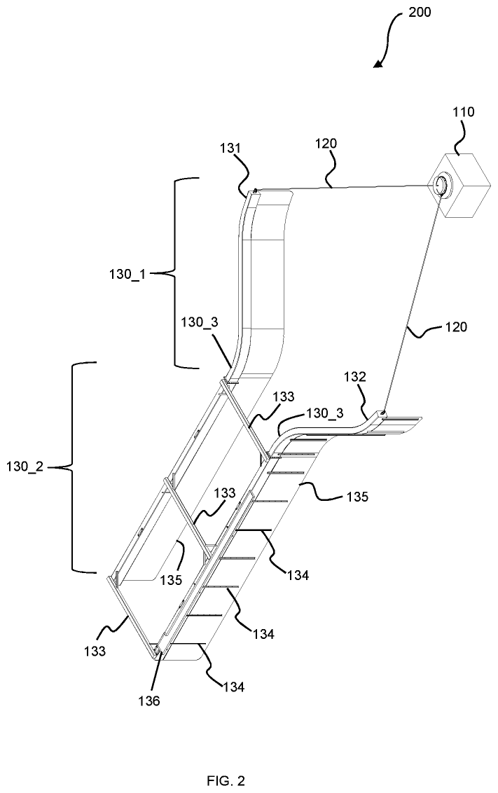

FIG. 2 illustrates the top view 200 of V-shaped floating frame 130 without first bucket turbine 151, second bucket turbine 152, electricity converting assembly 180, and wind funnel 140.

In one exemplary embodiment, V-shaped floating frame 130 has first curved arm 131 and a second curved arm 132 connected together by horizontal cross bars 133, which gives V-shaped floating frame a first section 130_1 broader than a second section 130_2. A neck section 130_3 is where the first section 130_1 ends and the second section (narrower) begins. V-shape floating frame 130 includes vertical bars 134 connected to both sides of first curved arm 131 and second curved arm 132 pointing downward to the sea floor. Durable sheets 135 are glued to vertical bars 134 along the entire length so as to be guided by the sea waves and to prevent V-shape floating frame 130 from being capsized. An oil leakage tray 136 is mounted on V-shaped floating frame 130 to make sure that no leakage oil drops from electricity converting assembly 180 is released to the sea.

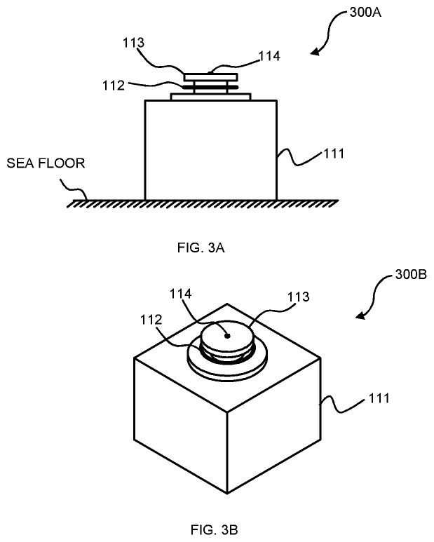

FIG. 3A is a side view 300A of anchor 110. In one exemplary embodiment, anchor 110 includes a base 111, a ring 112, a washer 112, and a bolt 114. Base 111 is made of a heavy material such as cement, iron, etc. so that base 111 sinks to the sea floor and cannot be easily moved by undercurrents. Ring 113 is laid directly on top of base 111 where bolt 114 is directly connected. Washer 113 has a diameter larger than the body but smaller than the top portion of bolt 114 so that washer 112 cannot be stripped out of anchor 110. Furthermore, washer 112 is used to connect V-shaped floating frame 130 to anchor 110. One near end of chord 120 is connected to washer 112 and the distal end is connected to first section 130_1 of V-shaped floating frame 130.

FIG. 3B is a top view 300B of anchor 110. With such embodiment, V-shaped floating frame 130 is adapted to rotate 360 degrees around anchor 110. As such, V-shaped floating frame 130 is always adjusted so that first section 130_1 is faced toward the direction of wind and sea waves. Consequently, V-shaped floating frame 130 receives the maximum energy generated by the wind and sea waves.

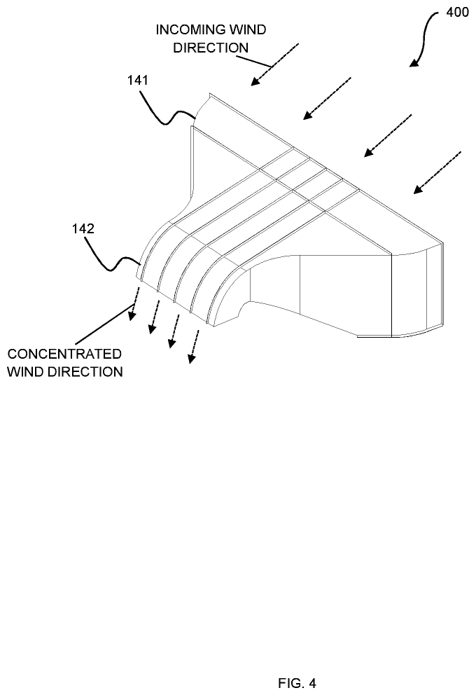

Now referring to FIG. 4, an oblique view 400 of wind funnel 140 in accordance with an exemplary embodiment of the present invention is illustrated. Wind funnel 140 includes a receiver end 141 and an output end 142. Receiver end 141 has a larger surface area designed to receive the incoming wind. The output end 142 is connected to and has substantially smaller surface area than receiver end 141. By the Venturi principle, the wind is more concentrated and has higher wind speed at the output end 142 than that at receiver end 141. In operation, the wind funnel 140 assists in rectifying the direction of V-shaped floating frame 130 so as to collect the wind energy that rotates first bucket turbine 151. It is understood that other wind funnel structures that create the same Venturi effect can also be used with V-shaped floating frame 130 of the present invention.

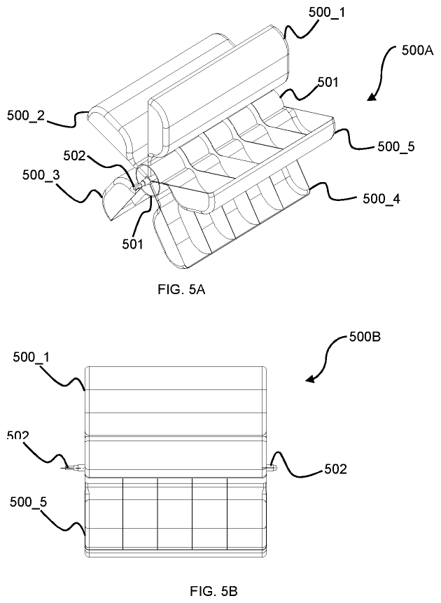

FIG. 5A and FIG. 5B illustrate the geometry of first bucket turbine 151 and second bucket turbine 152. FIG. 5A is an oblique view 500A and FIG. 5B is a top view of first bucket turbine 151 and second bucket turbine 152. The first bucket turbine 151 includes a cylindrical core 501, a shaft 502 concentric with and protruding out from both sides of cylindrical core 501. Blades 500_1 to 500_5 are mechanically connected to shaft 502 so that when blades 500_1 to 500_5 are rotated by the hydrodynamic force of the wind or sea waves, shaft 502 is also rotated. In the preferred embodiment of the present invention, blades 501_1 to 500_5 has the shape of a bucket, each having many chambers to increase the harvest of the energy of the wind and sea waves.

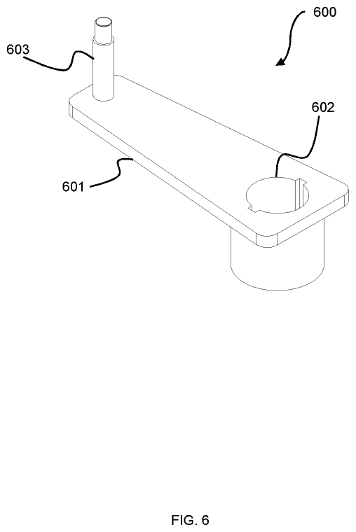

Now referring to FIG. 6, a crank 600 includes a pin 601, a body 602, and a crank hole 603. Crank hole 603 is mechanically connected to each of shaft 502 of first bucket turbine 151 and second bucket turbine 152. Pin 601 is fixedly connected to double-rod double acting cylinders (not shown).

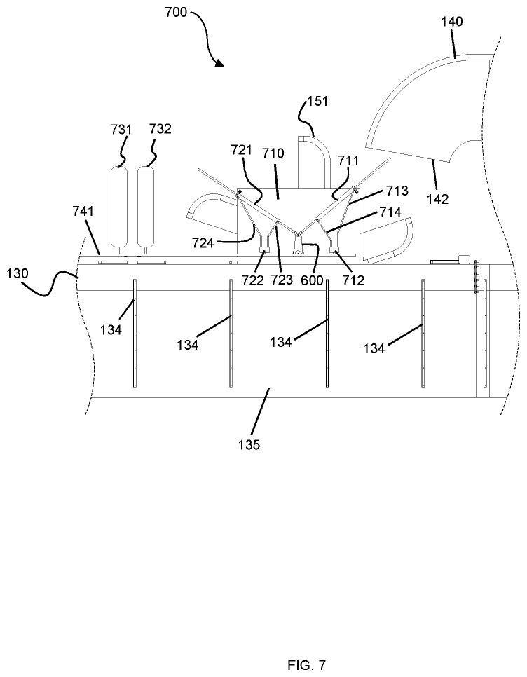

FIG. 7 illustrates a side view 700 of a first double rod double acting (“DRDA”) cylinder 711 and a second double rod double acting (“DRDA”) cylinder 721 and the manner they are connected to V-shaped floating frame 130 in accordance with an exemplary embodiment of the present invention. A first cylinder plate 710 is connected vertically to the side of either first curved arm 130_1 or second curved arm 130_2. First DRDA cylinder 711 is connected to a first H-bridge check-valve block 712 via a pair of check valve hoses 713 and 714. Similarly, second DRDA cylinder 721 is connected to a second H-bridge check-valve block 722 via a pair of check valve hoses 723 and 724. Both first DRDA cylinder 711, first check valve 712, second DRDA cylinder 721, and second H-bridge check-valve block 722 are mounted on first cylinder plate 710.

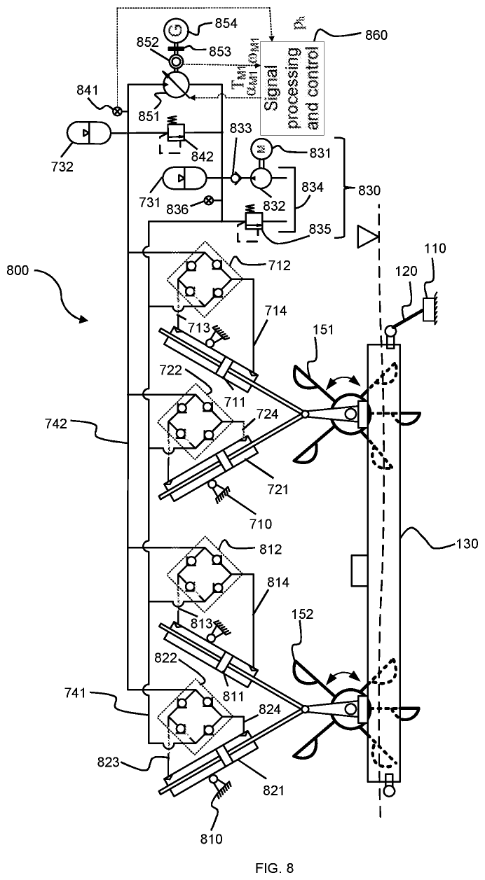

Continuing with FIG. 7, first H-bridge check-valve block 712 and second H-bridge check-valve block 722 are connected to a low-pressure line 741 and high-pressure line 742 (not shown) and to a high-pressure accumulator 731 and a low-pressure accumulator 732. Similar construction for first DRDA cylinder 711 and second cylinder 721 is applied to second bucket turbine 152 but is not shown to avoid confusion and crowding in FIG. 7. All connections and components will be shown in the following FIG. 8.

Now referring to FIG. 8 which illustrates a schematic diagram 800 of electricity converting assembly 180 and the interoperation between the mechanical section including anchor 110, a set of chords 120, V-shaped floating frame 130, first bucket turbine 151, second bucket turbine 152, wind funnel 140 and electricity converting assembly 180 to convert the wind and wave energy into electrical energy.

In one exemplary embodiment, electricity converting assembly 180 includes first bucket turbine 151 connected to first DRDA cylinder 711, first H-bridge check-valve block 712, second bucket turbine 152 connected a third DRDA cylinder 811, a third H-bridge check-valve block 812, a fourth bucket turbine 821, a fourth H-bridge check-valve block 822. First to fourth H-bridge check-valve blocks 712, 722, 812, and 822 are connected to low pressure line 741 and high-pressure line 742 and to low pressure accumulator 731 and high-pressure accumulator 732.

Continuing with the description of FIG. 8, electricity converting assembly 180 further includes a boost system 830 connected to low pressure accumulator 731 and high-pressure accumulator 732 via a low-pressure line 731 and high-pressure line 741 respectively. In one exemplary embodiment, boost system 830 further includes an electric motor 831, a hydraulic pump 832, a check valve 833, a low-pressure relief valve 835, all connected to low-pressure accumulator 731. A high-pressure relief valve 842 is connected to high-pressure accumulator 732 and to a pressure sensor 841. Both low-pressure line 721 and high-pressure line 742 are inputted into a hydraulic motor 851. Hydraulic motor 851 drives a clutch 853 of generator 854. A speed and torque sensor 852 is connected to sense the driving speed ϕ_{M1} of clutch 853. Finally, a signal processing and control circuit 860 receives output signals, Pₕ, from pressure sensor 841 and torque ϕ_{M1} from speed and torque sensor 852 to regulate the driving speed of hydraulic motor 851 which drives generator 854 to produce electrical power at a constant output level.

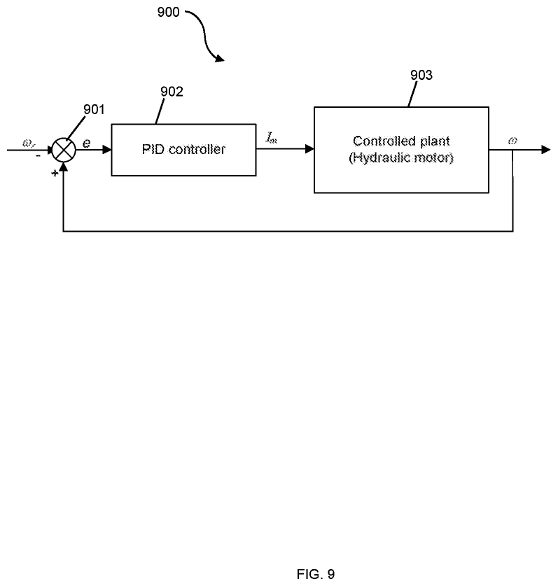

Referring to FIG. 9, a block diagram 900 of a control loop feedback between a signal processing and control circuit 860 and hydraulic motor 851 in accordance with an exemplary embodiment of the present invention. Signal processing and control circuit 860 continuously calculates an error value, e, as the difference between the reference speed ωᵣ and motor speed ω_{M} at a summation circuit 901. The correction is calculated at a Proportional Integral and Derivative (PID) controller 902. PID controller 902 attempts to minimize the error value, e, over time by adjustment of a control current I_{M}. The control current I_{M} is then used to drive hydraulic motor 851 by the following equation:

I_{M}=Kₚe+Kᵢ∫edt+K_{d}ė (1)

e=ωᵣ−ω_{M} (2)

Where, e is the speed error of the reference speed ωᵣ and motor speed ω_{M}. The coefficients Kₚ, Kᵢ and K_{d} were chosen with criteria of a small error, small overshoot, and fast response.

In operation, at first anchor 110 is set on the sea floor. V-shaped floating frame 130 is connected to anchor 110 using a set of chords 120. When wave energy converter 100 is floatingly placed near shore to generate electricity, incoming sea waves will cause V-shaped floating frame 130 to turn first section 130_1 to receive the wind and sea waves. By virtue of the geometry of V-shaped floating frame 130, wind and sea waves are channeled from first section 130_1 toward second section 130_2 at increasing speed to rotate first bucket turbine 151 and second bucket turbine 152.

As first bucket turbine 151 and second bucket turbine 152 rotate, they cause shafts 502 and cranks 600 to rotate, driving the rods of first double rod double acting (DRDA) cylinder 711, second DRDA cylinder 721, third DRDA cylinder 811, and fourth DRDA cylinder 821 in a linear in-out action. This linear in-out action pumps pressurized hydraulic fluid through low-pressure accumulator 731 and high-pressure accumulator 732 which, in turn, feed hydraulic motor 851. Hydraulic motor 851 creates a rotary motion that is needed to drive generator 854.

High-pressure fluids from first to fourth DRDA cylinders 711, 721, 811, and 821 are piped to high-pressure accumulator 96 through H-bridge check-valve block 712, 722, 812, and 822 respectively and high-pressure line 742. H-bridge check valve block 712, 722, 812, and 822 only allow low-pressure fluid from low-pressure line 731 into the cylinder 3 and high-pressure fluid from first to fourth DRDA cylinders 711, 721, 811, and 821 into high-pressure line 742 to charge high-pressure accumulator 732. The potential energy of high-pressure fluid stored in the high-pressure accumulator 732 is led to the hydraulic motor 100 to drive the generator 110. The bank of low pressure and high-pressure accumulators 731 and 732 is large enough to eliminate the fluctuation of input flow rate and store redundant energy.

In circuit 800 portrayed in FIG. 8, a low-pressure accumulator 731 and high-pressure accumulator 732 are used to minimize pulsations and to absorb shocks created by the irregularities of the sea. The pressure difference across hydraulic motor 851 causes the hydraulic fluid to flow from the high-pressure accumulator 732 to the low-pressure accumulator 731. Boost system 830 regulates the pressure drop over hydraulic motor 851. As it keeps the pressure constant, the hydraulic fluid will be drawn at a constant speed from high-pressure accumulator 732. Relief valve 842 releases the high pressure in the high-pressure accumulator 732 to protect the hydraulic circuit as the pressure becomes too high.

Signal processing and control circuit 860 further reduces the fluctuation in the electrical power generating process. As discussed above in FIG. 9, signal processing and control circuit 860 continuously minimize the error value, e, over time by adjustment of a control current I_{M} to provide a constant speed. The constant speed of motor 851 will ensure a constant output shaft speed and therefore a constant power output.

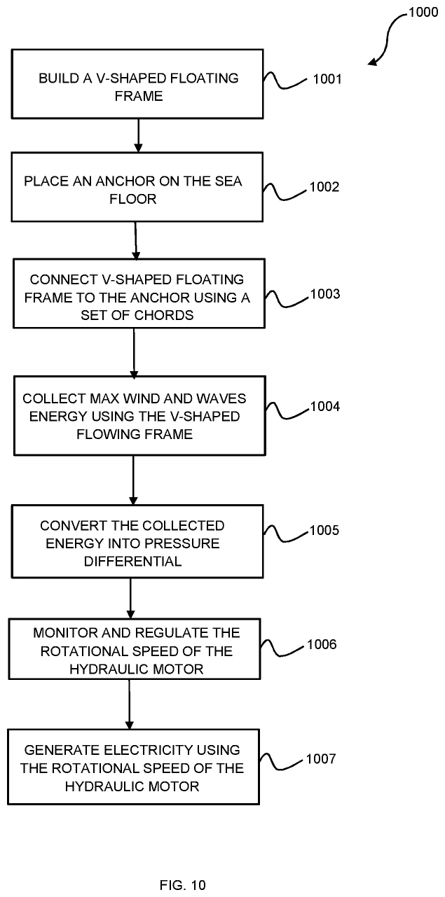

Finally, referring to FIG. 10, a flow chart illustrating a method 1000 for converting sea waves into electricity.

At step 1001, a V-shaped floating frame is built that include a first section and a second section that is narrower than the first section. The V-shaped floating frame is built which also includes a mechanical section and an electricity converting assembly. In one embodiment, the mechanical section includes V-shaped floating frame, first bucket turbine, second bucket turbine, wind funnel and electricity converting assembly to convert the wind and wave energy into electrical energy. In practice, step 1001 is realized by wave energy converter 900 discussed in FIG. 9.

At step 1002, an anchor is placed on the sea floor where strong waves usually arrive. Step 1002 is realized by anchor 110 as shown in FIG. 3A and FIG. 3B.

At step 1003, V-shaped floating frame is connected to the anchor by a set of chords. Step 1003 is realized by a set of chords 120 as shown in FIG. 1A-FIG. 1B.

At step 1004, V-shaped floating frame is used to collect the optimal wind and sea wave energy. Step 1004 is achieved by using wind funnel 140 and letting the wind and waves to turn V-shaped floating frame 130 toward the direction of wind and sea waves.

At step 1005, the collected hydrodynamic energy of wind and sea waves is converted into differential pressure. Step 1005 is achieved by using four double act double rod cylinders 711, 721, 811, and 821 coupled to first bucket turbine 151 and second bucket turbine 152 as shown in FIG. 7.

At step 1006, the differential pressure is constantly monitored and regulated. Step 1006 is achieved bank of accumulators 731 and 732 and boost system 830.

Finally at step 1007, electrical power is generated and regulated using the differential pressure from step 1006. Step 1007 is realized by hydraulic motor 851 and generator 854. The generated electrical power is regulated by signal processing and control circuit 860 coupled with pressure sensor 841 and speed and torque sensor 852.

The foregoing description details certain embodiments of the invention. It will be appreciated, however, that no matter how detailed the foregoing appears in the text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should, therefore, be construed in accordance with the appended claims and any equivalents thereof.

### DESCRIPTION OF NUMERALS

110 anchor
111 base
112 ring
113 washer
114 bolt
120 a set of chords rope
130 V-shaped floating frame
131 first curved arm of V-shaped floating frame
132 second curved arm of V-shaped floating frame
130_1 the first section of V-shaped floating frame
130_2 the second section of V-shaped floating frame
130_3 the neck section of V-shaped floating frame
133 horizontal cross bars of V-shaped floating frame
134 vertical bars of V-shaped floating frame
135 sheets
136 oil leakage collecting tray
140 wind funnel
141 receiver end of wind funnel
142 output end of wind funnel
151 first bucket turbine
152 second bucket turbine
180 electricity converting assembly
501 cylindrical core of bucket turbines
502 shaft of bucket turbines
500_1 first blade of bucket turbine frame
500_2 second blade of bucket turbine the wind funnel
500_3 third blade of bucket turbine
500_4 fourth blade of bucket turbine
500_5 fifth blade of bucket turbine
600 crank that connects the shaft 502 to cylinders
601 the body of the crank 600
602 the hole of the crank 600 for mounting to the turbine shaft 51
603 the pin of the crank 600 for connecting to the cylinder shaft 502
710 the first cylinder plate to support the DRDA cylinders
711 first DRDA cylinder of the cylinder plate 710
712 the first check valve block of the cylinder plate 710
713 the hose to the check valve block 712
714 the hose to the check valve block 712
721 the second DRDA cylinder of the cylinder plate 710
722 the second check valve block of the cylinder plate 710
723 the hose to the second check valve block 722
724 the hose to the second check valve block 722
731 the low-pressure accumulator
732 the high-pressure accumulator
741 the low-pressure line
742 the high-pressure line
810 the second cylinder plate to support the DRDA cylinders
811 first DRDA cylinder of the second cylinder plate 810
812 the first check valve block of the second cylinder plate 810
813 the hose to the check valve block 812
814 the hose to the check valve block 812
821 the second DRDA cylinder of the second cylinder plate 810
822 the second check valve block of the second cylinder plate 810
823 the hose to the second check valve block 822
824 the hose to the second check valve block 822
830 boost system
831 electric motor of boost system
832 hydraulic pump of boost system
833 check valve of boost system
834 hydraulic oil tank
835 relief valve of boost system
836 pressure gauge of boost system
841 pressure sensor of the hydraulic circuit 80
842 relief valve of the hydraulic circuit 80
851 the hydraulic motor
852 speed and torque sensor
853 clutch of the electric generator
854 the electric generator
860 signal processing and control circuit
901 comparison block
902 PID controller block
903 controlled plant

What is claimed is:

1. A wave energy converter, comprising:
a V-shaped floating frame having a first end and a second end that is narrower than said first end so as to form a V-shaped structure which is hollow in the middle;
an anchor base mounted at the bottom of the sea and connected to said V-shaped floating frame at said first end by a set of strings so that said V-shaped floating frame automatically rotate said first end toward the direction of wind and sea waves;
a first bucket turbine placed in the hollow section and connected to the neck of said V-shaped floating frame where said first end ends and said second end begins so that said first bucket turbine is partially submerged in the sea;
a second bucket turbine placed in the hollow section and connected to said second end so that said second bucket turbine is partially submerged in the sea; and
an electricity converting assembly operable to receive and convert energy generated by said first bucket turbine and said second bucket turbine into electricity.

2. The wave energy converter of claim 1 further comprising a wind funnel, mounted on top of said first end, adapted to channel a wind energy to said first bucket turbine.

3. The wave energy converter of claim 1 wherein said electricity converting assembly further comprises:
a plurality of double-rod double-acting (“DRDA”) cylinders, mechanically connected to said first bucket turbine and to said second bucket turbine, operable as hydraulic pumps to generate a high-pressure fluid and a low-pressure fluid as said first bucket turbine and said second bucket turbine are rotated by the hydrodynamic energy of the sea waves;
a low-pressure accumulator and a high-pressure accumulator both connected to said plurality of DRDA cylinders adapted to absorb shocks caused by the irregularities of the sea waves;
an H-bridge check-valve block, connected to said plurality of DRDA cylinders and said low-pressure accumulator and said high-pressure accumulator, adapted to direct said low-pressure fluid into said low-pressure accumulator and said high-pressure fluid to said high-pressure accumulator;
a hydraulic motor, connected to said high-pressure accumulator and said low-pressure accumulator, operable to receive said high-pressure fluid and said low-pressure fluid to create a hydraulic pressure;
a generator, connected to said hydraulic motor, operable to generate electricity using an angular displacement caused by said hydraulic pressure; and
a controller, electrically connected to said hydraulic motor, operable to regulate the output of said angular displacement so as to produce electricity at a predetermined power level.

3. The wave energy converter of claim 2 wherein said electricity converter system further comprises:
a low-pressure line, mechanically connected to said H-bridge check valve block, said low-pressure accumulator and said hydraulic motor; and
a high-pressure line mechanically connected to said H-bridge check and valve block, said high pressure and said hydraulic motor.

4. The wave energy converter of claim 3 wherein said electricity converting assembly further comprises:
a first relief valve connected to said low-pressure accumulator; and
a second relief valve connected to said high-pressure accumulator.

5. The wave energy converter of claim 4 wherein said electricity converting assembly further comprises:
a plurality of pressure sensors connected to said high-pressure line and said low-pressure line; and
a torque sensor connected to the output of said hydraulic motor and the input of said generator.

6. The wave energy converter of claim 2 wherein said plurality of double-rod double-acting cylinders further comprises:
a first double-rod, double acting (“DRDA”) cylinder, mechanically connected to a turbine shaft of said first bucket turbine by a first crank shaft;
a second double-rod, double acting (“DRDA”) cylinder, mechanically connected to said turbine shaft of said first bucket turbine by said first crank shaft;
a third double-rod, double acting (“DRDA”) cylinder, mechanically connected to a turbine shaft of said second bucket turbine by a second crank shaft;
a fourth double-rod double acting (“DRDA”) cylinder, mechanically connected to said turbine shaft of said second bucket turbine by said second crank shaft.

7. The wave energy converter of claim 3 wherein said turbine shaft of said first bucket turbine is mechanically connected to said V-shaped floating frame by a first bearing and a second bearing, and wherein said turbine shaft of said second bucket turbine is mechanically connected to said V-shaped floating frame by a third bearing and a fourth bearing.

8. The wave energy converter of claim 4 wherein said first double rod double acting cylinder and said second double rod double acting cylinder each has a rod mechanically connected to said crank shaft of said first bucket turbine and wherein each of said cylinder has an external connector mechanically connected to a first cylinder plate vertically connected to said V-shaped floating frame.

9. The wave energy converter of claim 5 wherein said third double rod double acting cylinder and said fourth double rod double acting cylinder each has a rod mechanically connected to said crank shaft of said second bucket turbine and wherein each of said third cylinder and said fourth cylinder has an external connector mechanically connected to a second cylinder plate vertically connected to said V-shaped floating frame.

10. The wave energy converter of claim 1 wherein said H-bridge check and valve block further comprises:
a first H-bridge check-valve connected to said first double rod double acting cylinder, said high-pressure line and said low-pressure line;
a second H-bridge check-valve connected to said second double rod and double acting cylinder, said high-pressure line and said low-pressure line;
a third H-bridge check-valve connected to said third double rod double acting and valve, said high-pressure cylinder a second H-bridge check line and said low-pressure line; and
a fourth H-bridge check-valve connected to said fourth double rod and double acting cylinder, said high-pressure line and said low-pressure line.

11. The wave energy converter of claim 1 wherein said V-shaped floating frame further comprises:
a first curved arm;
a second curved arm;
a plurality of cross tubes horizontally connected said first curved arm and said second curved arm so as to form said V-shaped structure;
a plurality of vertical bars vertically connected along the length of each said first curved arm and said second curved arm; and
a sheet adhered to said plurality of vertical bars covers the entire length of said first curved arm and said second curved arm so as to prevent said V-shaped floating frame from being overturned by the sea waves.

12. The wave energy converter of claim 11 wherein said V-shaped floating frame further comprises:
an oil leakage tray vertically connected to either said first curved arm or said second curved arm where said plurality of double-rod double-acting (“DRDA”) cylinders are mounted.

13. The wave energy converter of claim 1 wherein said anchor is mounted at the bottom of the sea where said V-shaped floating frame is placed, wherein said anchor further comprises:
a base mounted at the bottom of the sea where said V-shaped floating frame is set up;
a ring laid directly on top and at the center of said base;
a bolt laid on top and concentric with said ring, adapted to secure said set of ropes that connect said V-shaped floating frame to said base.

14. The wave energy converter of claim 1 wherein said controller uses a control current as a function of an error between a reference rotational speed and a motor rotational speed to drive said hydraulic motor according to a function:
I_{M}=Kₚe+Kᵢ∫edt+K_{d}ė
e=ωᵣ−ω_{M}, where, e is the speed error of said reference rotational speed ωᵣ and said motor rotational speed ω_{M} and coefficients Kₚ, Kᵢ and K_{d} being coefficients which yield a small error, a small overshoot, and a fast response for said hydraulic motor.

15. A method of harnessing electricity from wave energy of an ocean, comprising:
receiving hydrodynamic energy of sea waves;
eliminating losses of said hydrodynamic energy of sea waves;
converting said hydrodynamic energy into potential energy;
converting said potential energy into electricity; and
regulating said potential energy so as to obtain a substantially constant electrical energy.

16. The method of claim 15 wherein said receiving a hydrodynamic energy of sea waves further comprises:
constructing a V-shaped floating frame comprising: a first end and a second end that is narrower than said first end so as to form a V-shaped structure; a first bucket turbine, connected to the neck of said V-shaped floating frame where said first end ends and said second end begins; a wind funnel mounted on top of said first end, adapted to channel a wind energy to said first bucket turbine; a second bucket turbine connected to said second end; and an electricity converting assembly connected to said first bucket turbine and to said second bucket turbine;
placing an anchor at the bottom of the sea and connecting to said V-shaped floating frame at said first end by a set of ropes so that said V-shaped floating frame automatically rotate said first end toward a coming sea wave direction.

17. The method of claim 16 wherein said converting said hydrodynamic energy into potential energy further comprises constructing said electricity converting unit which further comprises:
a plurality of double-rod double-acting (“DRDA”) cylinders, mechanically connected to said first bucket turbine and to said second bucket turbine, operable as hydraulic pumps to generate a high-pressure fluid on both sides of each of said plurality of DRDA cylinders as said first bucket turbine and said second bucket turbine are rotated by the hydrodynamic force of the wave energy;
a low-pressure accumulator and a high-pressure accumulator both connected to said plurality of double rod double acting cylinders adapted to absorb shocks caused by the irregularities of the incoming sea waves;
an H-bridge check valve block, connected to said plurality of double rod double-acting cylinders and said low-pressure accumulator and said high-pressure accumulator, adapted to direct a low-pressure fluid into said low-pressure accumulator and a high-pressure fluid from cylinders to the high-pressure accumulator;
a hydraulic motor, connected to said high-pressure accumulator and said low-pressure accumulator, operable to receive said high-pressure fluid and said low-pressure fluid to create a hydraulic pressure and to convert said hydraulic pressure into torque and angular displacement;
a generator, connected to said hydraulic motor, operable to generate electricity using said torque and said angular displacement received from said hydraulic motor; and
a controller, electrically connected to said hydraulic motor, operable to regulate the output of said torque and said angular displacement so as said generator is to produce electricity at a predetermined power level.

18. The method of claim 17 wherein said eliminating losses of said hydrodynamic energy of sea waves further comprises:
accumulating and regulate high-pressure fluid from the hydraulic cylinders;
absorbing the redundant power received from sea wave for later using when the receiving power is higher than the rated power of the generator; and
compensating the deficit power to the hydraulic motor when the receiving power is lower than the rated power of the generator.

19. The method of claim 17 wherein said converting said potential energy into electricity further comprises using a hydraulic motor, connected to said high pressure accumulator and said low pressure accumulator, operable to receive said high pressure fluid and said low pressure fluid to create a hydraulic pressure and to convert said hydraulic pressure into torque and angular displacement; and
using a generator, connected to said hydraulic motor, operable to generate electricity using said torque and said angular displacement received from said hydraulic motor.

20. The method of claim 18 wherein said regulating said potential energy so as to obtain a substantially constant electrical energy further comprises uses a control current as a function of an error between a reference rotational speed and a motor rotational speed to drive said hydraulic motor according to a function:
I_{M}=Kₚe+Kᵢ∫edt+K_{d}ė
e=ωᵣ−ω_{M}, where, e is the speed error of said reference rotational speed ωᵣ and said motor rotational speed ω_{M} and coefficients Kₚ, Kᵢ and K_{d} being coefficients which yield a small error, a small overshoot, and a fast response for said hydraulic motor.
